(19) United States
(12) Patent Application Publication
(10) Pub. No.: US 2026/0188064 A1
(43) Pub. Date: Jul. 2, 2026

(54) SYSTEM AND METHOD FOR ESTIMATING COMPONENT LIFETIME

(71) Applicant: Torc Robotics, Inc., Blacksburg, VA (US)

(72) Inventors: Adam N. Schneider, Christiansburg, VA (US); Matthew Swanson, Blacksburg, VA (US)

(21) Appl. No.: 19/004,916

(22) Filed: Dec. 30, 2024

(51) Int. Cl. G07C 5/08; G07C 5/00

(52) U.S. Cl. CPC G07C 5/085; G07C 5/006

(57) ABSTRACT

A system for estimating a lifetime of a component of a vehicle is provided. The system includes one or more sensors associated with the vehicle, and a processing device configured to execute instructions to perform operations for component lifetime estimation. The operations include acquiring sensor data from the one or more sensors for one or more parameters. The one or more parameters are indicative of one or more factors affecting a lifetime of a component of the vehicle. The operations include executing a lifetime module to determine, using the sensor data and a lifetime model, accumulated exposure of the component to the one or more factors. The operations include determining, using the accumulated exposure of the component, a remaining lifetime of the component.

### TECHNICAL FIELD

The field of the disclosure relates to component lifetime estimation and, in particular, to a system configured to estimate a lifetime of a component based on exposure of the component to certain parameters during usage.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Vehicles therefore have a variety of components, e.g., hardware components, or the like, used to operate the perception, localization, behaviors and planning, and control functionalities. Failure of one or more of these components can result in improper operation of the vehicle. Automotive components, e.g., hardware components, or the like, are typically qualified for a set lifetime using qualification profiles based on an industry standard, e.g., ISO-16750, Daimler's Standard MBN 10306, Daimler's Standard MBN 60306, or the like. The qualification profiles are typically static accelerated test profiles based on mounting locations and stresses experienced in the on-road environment, e.g., salt, fog, thermal, vibration, or the like. The determined lifetime for the component is set across-the-board to all components of the same type/model, and when the lifetime is reached (or before reaching the lifetime), the component is automatically replaced. This can result in increased planned or scheduled maintenance costs associated with the vehicle, despite the component still having the ability to perform beyond the preset lifetime.

Accordingly, there exists a need for a system and a method of estimating a lifetime of a component for a vehicle based on usage and environmental exposure of the component to allow for continued use of the component beyond the preset lifetime. These and other needs are met by the exemplary system for estimating component lifetime discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for estimating a lifetime of a component of a vehicle is provided. The system includes one or more sensors associated with the vehicle. The system includes a processing device in communication with the one or more sensors. The processing device is configured to execute instructions stored in a memory to perform operations that include acquiring sensor data from the one or more sensors for one or more parameters. The one or more parameters are indicative of one or more factors affecting a lifetime of a component of the vehicle. The operations include executing a lifetime module to determine, using the sensor data and a lifetime model, accumulated exposure of the component to the one or more factors. The operations include determining, using the accumulated exposure of the component, a remaining lifetime of the component.

In some embodiments, the vehicle can be an autonomous vehicle. In some embodiments, the vehicle can be a semi-autonomous vehicle or a non-autonomous vehicle. In some embodiments, the one or more sensors can include a thermostat to measure temperature. In some embodiments, the one or more sensors can include a vibration sensor to measure vehicle vibration. In some embodiments, the one or more sensors can include an odometer to measure vehicle mileage. In some embodiments, the one or more sensors can include a humidity sensor to measure humidity. In some embodiments, the one or more sensors can include a combination of different sensors and an accumulation of multiple parameter data can be used to estimate the lifetime of the component.

In some embodiments, the one or more parameters can include temperature, vehicle vibration, vehicle mileage, and/or humidity. In some embodiments, the component can include a camera, a vehicle sensor, light detection and ranging (LiDAR), and/or radio detection and ranging (RADAR). In some embodiments, the one or more sensors can be configured to generate the sensor data in real-time (or substantially real-time). In some embodiments, the one or more sensors are configured to generate the sensor data in predetermined time intervals (e.g., hourly, daily, weekly, or the like).

In some embodiments, the component is an electric device associated with the vehicle. In some embodiments, the component can be a mechanical device associated with the vehicle. The operations can include generating an alert via a user interface when the determined remaining lifetime of the component is below a lifetime threshold. In some embodiments, the alert can be generated if the determined remaining lifetime of the component is less than a time period for a mission route to be completed by the vehicle, thereby allowing for replacement of the component before the mission route is initiated. This can avoid potential failure of the component along the mission route. If the determined remaining lifetime of the component is below a lifetime threshold, the operations can include automatically scheduling a maintenance event to replace or repair the component.

The operations can include generating a mission route for the vehicle such that the component operates within the remaining lifetime during the mission route. In some embodiments, the lifetime model can include an ISO-16750 standard model. The lifetime model can be a prediction model. The operations can include electronically storing the sensor data in a database. The sensor data can be indicative of environmental and operational standards in which the component was used with the vehicle. This data can be used as support to show that the component was used in the proper conditions and manner if premature failure occurs.

In another aspect, an exemplary computer-implemented method for estimating a lifetime of a component of a vehicle is provided. The computer-implemented method includes acquiring sensor data from one or more sensors associated with the vehicle for one or more parameters. The one or more parameters are indicative of one or more factors affecting a lifetime of a component of the vehicle. The method includes executing instructions stored in a memory with a processing device in communication with the one or more sensors to perform operations that include executing a lifetime module to determine, using the sensor data and a lifetime model, accumulated exposure of the component to the one or more factors. The operations include determining, using the accumulated exposure of the component, a remaining lifetime of the component. In some embodiments, the one or more sensors can include a thermostat to measure temperature, a vibration sensor to measure vehicle vibration, an odometer to measure vehicle mileage, and/or a humidity sensor to measure humidity.

In one aspect, an example system for or monitoring one or more components of a vehicle is provided. The system can include one or more processors and a memory storing computer instructions. The computer instructions when executed by the one or more processors can cause the system to (i) acquire, from a vibration sensor of the vehicle, first vibration data over one or more time segments, (ii) determine, based on the first vibration data, second vibration data indicative of vibrations experienced by a component of the vehicle, the component is at a different location in the vehicle compared to the vibration sensor, (iii) determine, using the second vibration data and a lifetime model, accumulated exposure of the component to one or more factors, and (iv) determine, using the accumulated exposure of the component, a remaining lifetime value of the component.

In some implementations, the one or more processors can be configured to transform the first vibration data from time domain to a vibration profile in frequency domain, and determine the second vibration data using the vibration profile in the frequency domain.

In some implementations, the one or more processors can be configured to determine the second vibration data using a model determined based on test vibration data for the vibration sensor and test vibration data for the component.

In some implementations, the lifetime model can include an ISO-16750 standard model. In some implementations, the system can be an onboard system of the vehicle. In some implementations, the vibration sensor can be configured to measure vibration at a frequency between 90 Hz and 110 Hz. In some implementations, the vibration sensor can be configured to measure vibration at a frequency between about, e.g., 1 Hz to 10 Hz inclusive, 1 Hz to 10,000 Hz inclusive, or the like. In some implementations, the one or more processors can be configured to determine the remaining lifetime value of the model using a prediction model.

In some implementations, the one or more processors can be configured to perform at least one of causing an indication of the lifetime value to be displayed on a dashboard of the vehicle, or provide the indication of the lifetime value to remote computer device.

In some implementations, the one or more processors can be configured to determine that the lifetime value is smaller than a threshold value, and generate an alert signal responsive to determining that the lifetime value is smaller than the threshold value.

In some implementations, the component can include a camera of the vehicle, a connectivity device, a light detection and ranging (LiDAR) sensor or a radio detection and ranging (RADAR) sensor. In some implementations, the component can include an electric component of the vehicle. In some implementations, the system can include the vibration sensor.

In another aspect, an example method for monitoring one or more components of a vehicle is provided. The method can include acquiring, by one or more processors, from a vibration sensor of the vehicle, first vibration data over one or more time segments, determining, by the one or more processors, based on the first vibration data, second vibration data indicative of vibrations experienced by a component of the vehicle, the component is at a different location in the vehicle compared to the vibration sensor, determining, by the one or more processors, using the second vibration data and a lifetime model, accumulated exposure of the component to one or more factors, and determining, by the one or more processors, using the accumulated exposure of the component, a remaining lifetime value of the component.

In some implementations, the method can include transforming, by the one or more processors, the first vibration data from time domain to a vibration profile in frequency domain, and determining, by the one or more processors, the second vibration data using the vibration profile in the frequency domain.

In some implementations, the method can include determining, by the one or more processors, the second vibration data using a model determined based on test vibration data for the vibration sensor and test vibration data for the component.

In some implementations, the lifetime model can include an ISO-16750 standard model. In some implementations, the system can be an onboard system of the vehicle. In some implementations, the vibration sensor can be configured to measure vibration at a frequency between 90 Hz and 110 Hz. In some implementations, the vibration sensor can be configured to measure vibration at a frequency between about, e.g., 1 Hz to 10 Hz inclusive, 1 Hz to 10,000 Hz inclusive, or the like. In some implementations, the method can include determining, by the one or more processors, the remaining lifetime value of the model using a prediction model.

In some implementations, the method can include at least one of causing, by the one or more processors, an indication of the lifetime value to be displayed on a dashboard of the vehicle, or providing, by the one or more processors, the indication of the lifetime value to remote computer device.

In some implementations, the method can include determining, by the one or more processors, that the lifetime value is smaller than a threshold value, and generating, by the one or more processors, an alert signal responsive to determining that the lifetime value is smaller than the threshold value.

In some implementations, the component can include a camera of the vehicle, a connectivity device, a light detection and ranging (LiDAR) sensor or a radio detection and ranging (RADAR) sensor. In some implementations, the component can include an electric component of the vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for estimating component lifetime.

FIG. 7 is a flowchart of a method for estimating component lifetime.

FIG. 8 is a flowchart for executing a dynamic life model to determine an estimated component lifetime.

FIG. 9 is a flowchart for executing a dynamic life model to determine an estimated component lifetime, including humidity as a factor.

FIG. 10 is a chart showing measured data and an estimation/prediction of component lifetime compared to an industry standard lifetime threshold.

FIG. 11 is a schematic side view of the autonomous truck of FIG. 1.

FIG. 12 is a flow chart of a method for monitoring one or more components of a vehicle, according to an example embodiment of the current disclosure.

FIG. 13A depicts a plot of an example vibration profile in frequency domain of a vehicle, according to an example embodiment of the current disclosure.

FIGS. 13B and 13C depict plots of vibration damage accumulation (FIG. 13B) and temperature damage accumulation (FIG. 13C), according to an example embodiment of the current disclosure.

FIG. 14 is a flow diagram depicting an example implementations of the method of FIG. 12, according to example embodiment of the current disclosure

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for estimating component failure allows for a real-time (or substantially real-time) determination of exposure of the component to usage and/or environmental factors and, based on these values, determining if the component lifetime can exceed the preset industry standard threshold (that the component was qualified for). As discussed herein, the preset industry standard threshold for the lifetime of a component is typically determined using static accelerated test profiles based on expected mounting locations and expected stresses experienced in the on-road environment. Such testing can include consideration of a variety of parameters/factors, e.g., salt, fog, thermal, vibration, humidity, or the like. Based on the testing, the preset lifetime for the component is used for all of the same type/model of the component. The preset lifetime for the component can be adjusted based on the mounting location of the component, e.g., outside vs inside of the vehicle. However, the actual usage and exposure of the component may differ from the testing usage and exposure, resulting in the component having either a lower lifetime or a higher lifetime than determined from the testing.

For example, a component may have a lifetime of 500,000 miles which is estimated to be accumulated within two years of the vehicle usage, and the industry or manufacturer recommendation may be to replace the component within either 500,000 miles or within two years of usage. The actual usage of the vehicle over the two-year period may not reach the 500,000-mile level. For example, the actual usage of the vehicle may result in five years of usage before reaching 500,000 miles, and the component lifetime may be extendable for five years instead of the industry preset (or component qualified) two years. Rather than premature replacement of the component, based on actual usage and exposure of the component in the specific vehicle in which it is used, the usage of the component can be extended. Similarly, the actual usage of the vehicle can result in reaching the 500,000 mile level in less than two years (e.g., due to additional stress encountered than planned), shortening the component lifetime and requiring earlier replacement than the industry preset of two years.

The exemplary system therefore relies on sensors of the vehicle to monitor the usage and exposure of components to certain factors which affect the component lifetime, and estimates the remaining lifetime of the component. The sensor data can be obtained from dedicated sensors configured to monitor the component usage, from sensors previously located on the vehicle, sensors natively installed in the component itself, or combinations thereof. The sensor data can be used to determine the accumulation of usage and/or exposure of the component in an accurate manner and specific to each vehicle, since all vehicle usage can differ.

For example, a vehicle operating in mostly harsh conditions (e.g., freezing temperatures, or the like) would likely have a reduced component lifetime as compared to a vehicle operating in more standard conditions. As a further example, a vehicle operating in mostly mountainous terrain may have a reduced component lifetime as compared to a vehicle operating in mostly flat terrain. As a further example, a vehicle operating mostly on roads having a lower quality (e.g., based on the international roughness index) may have a reduced component lifetime as compared to a vehicle operating on mostly higher quality roads. A central on-board software application can be executed by the processing device of the vehicle (or can be performed externally from the vehicle) to monitor, e.g., temperatures and other lifetime critical factors from the sensors, and converts the data to a remaining lifetime value.

The system can be used to determine if the estimated lifetime of the component is below the industry preset lifetime, e.g., due to increased usage and/or exposure of the component, or if the estimated lifetime of the component exceeds the industry preset lifetime, e.g., due to reduced usage and/or exposure of the component. Based on this estimation, the system can determine if the component should be replaced via scheduling a maintenance event, or if continued use of the component is permitted. The system can therefore provide for flexibility in component replacement, as well as cost savings with respect to maintenance of vehicles.

Use of the system to determine the remaining useful life with respect to environmental factors of each (or many) installed component on the vehicle provides several advantages to operation of the vehicle. The system provides for an improvement in preventative maintenance planning (e.g., reduced premature replacement of components), allows for a confirmation of accuracy in testing methodologies when determining industry preset lifetimes, and (in some instances) can be used to guarantee to suppliers and regulatory agencies that the components have been used within the environment specifications for safety critical refurbishment. For example, the sensor data can be used as proof of the proper use of the component in the intended conditions and under the manufacturer specifications if premature failure occurs and replacement is requested, e.g., under a warranty, or the like. In some embodiments, for instances where additional stress has occurred, the system can reduce operational costs due to in mission failures due to reduces recoveries/assistance events (e.g., when a failure is mitigated by replacing a component based on the system recommendation rather than running it to failure).

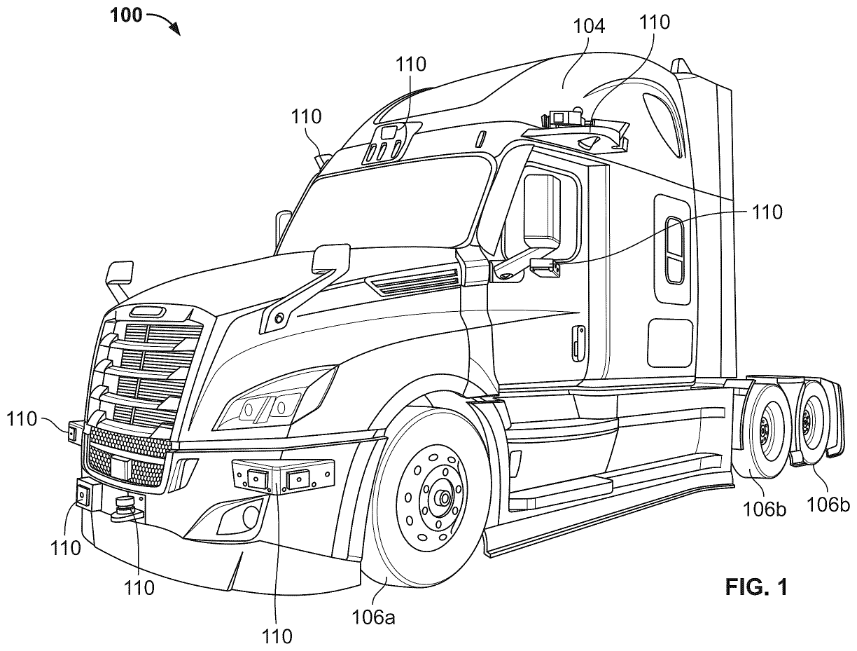

Various embodiments in the present disclosure are described with reference to FIGS. 1-14 below.

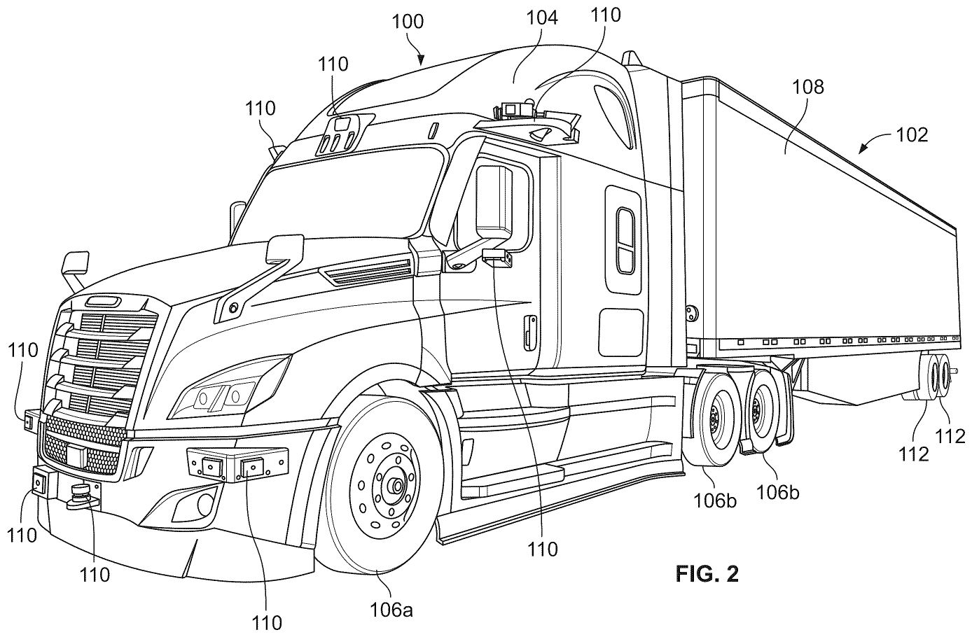

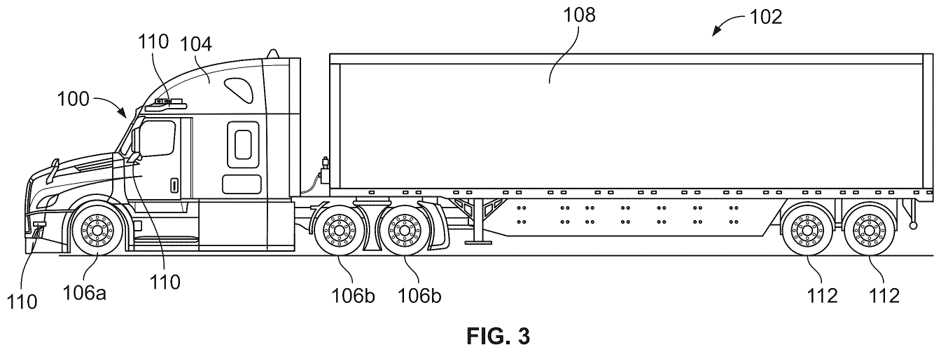

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

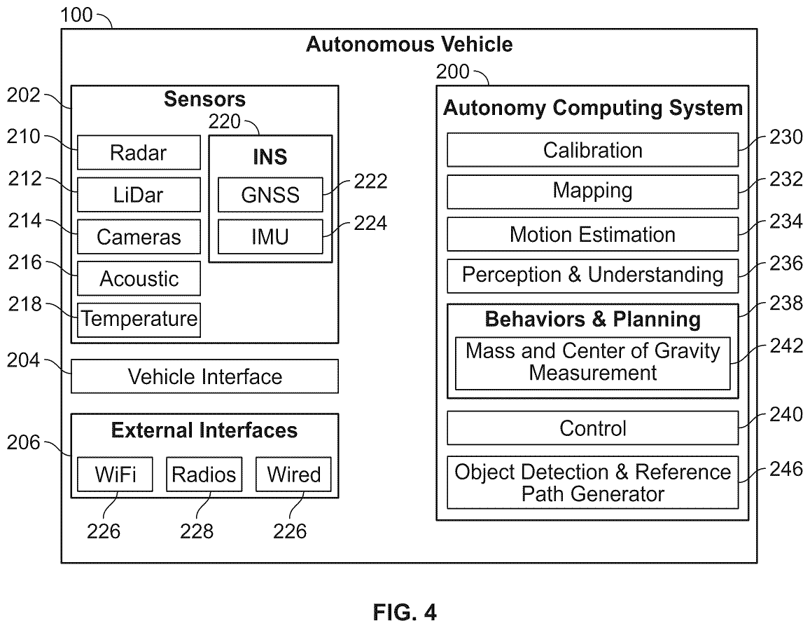

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

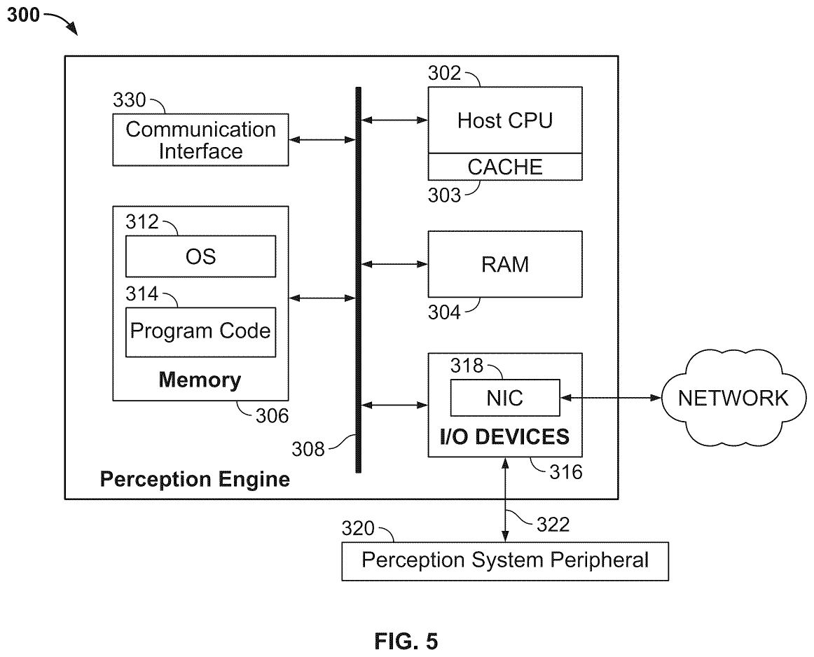

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

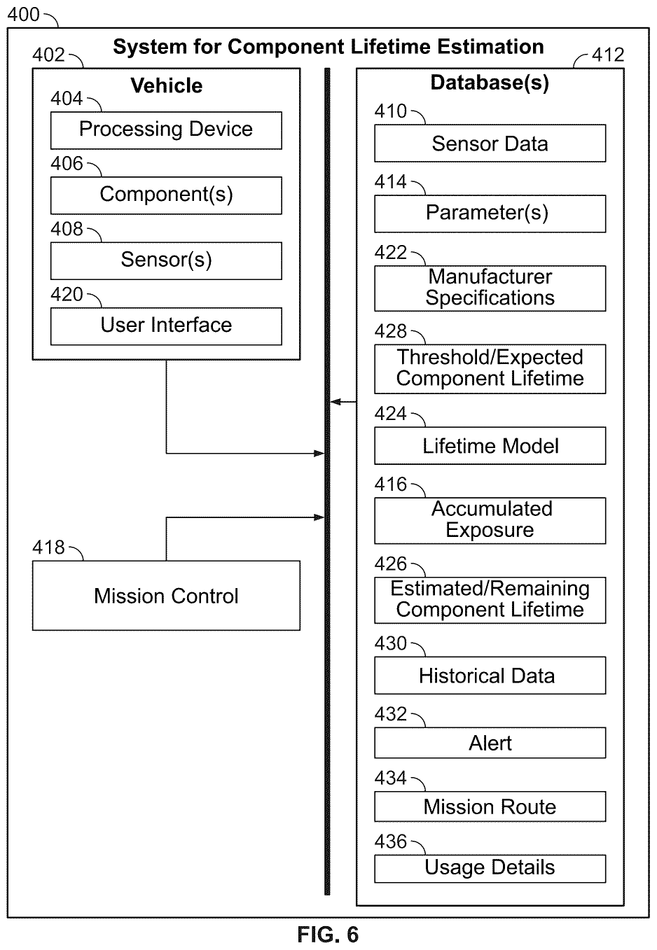

FIG. 6 is a block diagram of an exemplary system 400 for component lifetime estimation. The system 400 generally includes one or more vehicles 402 (e.g., autonomous vehicle 100). Each vehicle 402 includes a processing device 404 (e.g., computing system 200, computing system 300, or the like) configured to receive and process data for estimating the lifetime of one or more components 406 of the vehicle 402. In some embodiments, the components 406 can be electrical devices, mechanical devices, or a combination thereof. For example, the components 406 can include sensors (e.g., sensors 202) associated with the vehicle 402 that are used for, e.g., perception technology, or the like. In some embodiments, the components 406 can include, e.g., perception sensors (cameras, infrared cameras, LiDAR (short range/long range), radar, microphones, or the like), connectivity solutions (computers, radios, 4G devices, satcom transceivers, 5G devices, or the like), high performance computers (usually GPU based) to enable AI solutions, user interface devices (screens, microphones, or the like), networking components (data loggers, Ethernet/PCIe switches, modem routers, or the like), base vehicle sensors (wheel speed, steering angle, braking, or the like), any heritage auto sensor technology, combinations thereof, or the like.

At least some of the data received by the processing device 404 can be data from one or more sensors 408 associated with the vehicle 402. In some embodiments, the sensors 408 can be existing sensors (e.g., sensors 202) of the vehicle 402 that assist with general operation of the vehicle 402. In some embodiments, the sensors 408 can be dedicated sensors added to the vehicle 402 to focus on gathering data associated with the respective components 406. The sensors 408 can include one or more of, e.g., a camera, light detection and ranging (LiDAR), radio detection and ranging (RADAR), combinations thereof, or the like. The sensors 408 can include, e.g., thermostats or thermal sensors configured to measure the temperature of the component 406 and/or the environment around the component 406, vibration sensors configured to measure the vehicle vibration or vibration of the component 406, an odometer for measuring the vehicle mileage, a humidity sensor to measure the humidity in the environment around the component 406, combinations thereof, or the like. In some embodiments, the sensors 408 can include UV radiation sensors (e.g., for plastic deformation and measuring irradiance in W/m²), thereby determining UV deterioration. In some embodiments, the sensors 408 can be in the form of a power cycle counter in a software application. In some embodiments, the sensors 408 can be associated with mechanical components, e.g., in pumps, or the like, and can include encoders and encoder varieties, Hall effect sensors, flow meters for pumps, sensors capable of measuring revolutions to determine lifetime of spinning mechanisms, combinations thereof, or the like.

The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. In some embodiments, the database 412 can be stored at mission control 418, which is in communication with the vehicle 402 for transmitting/receiving data. The vehicle 402 can include a user interface 420, e.g., a graphical user interface, usable to input and/or output data. In some embodiments, the user interface 420 can be used to issue an alert based on the data from the sensors 408, as discussed herein.

The sensors 408 detect/measure data 410 electronically stored in a database 412 for processing to estimate the lifetime of each component 406. The sensors 408 are focused on gathering data for various parameters 414 which are indicative of factors affecting the lifetime of the components 406. The parameters 414 can include, e.g., temperature, vibration, vehicle mileage, humidity, acceleration/deceleration, unit power cycle count, vehicle power on hours, damp heat (temperature/humidity), shock events (separate from vibration, such as car door slam or shock from hitching a trailer), UV radiation (which affects plastics), exposure to corrosive chemicals, combinations thereof, or the like. The sensor data 410 associated with each of the parameters 414 can be collected and stored over in real-time or substantially real-time as the vehicle 402 is used, with the sensor data 410 generated an accumulated exposure 416 value for each parameter 414 and the respective component 406.

The accumulated exposure 416 can be based on the manufacturer specifications 422 for each specific component 406. For example, if a component 406 can only be exposed to temperatures above a predetermined threshold for a specified period of time, the sensors 408 can be used to detect when the component 406 has been exposed to temperatures above this predetermine threshold and the period of time for which exposure has occurred. As the vehicle 402 is used and the exposure of the component 406 continues or repeats, the accumulated exposure 416 time can be stored in the database 412. In some embodiments, the accumulated exposure 416 can be measured for any parameter 414 or each specific component 406. For example, if a component 406 is impacted by high temperature stress, temperature at the installation location can be measured by an internal thermistor (or other sensor). The sensors 408 that are used to measure the temperature communicate to the processing device 404 to accumulate time series data of this measurement over the life cycle of the vehicle 402. As the vehicle 402 is used and the exposure of the component 406 continues or repeats, the accumulated exposure 416 time can be stored in the database 412.

Similarly, if a component 406 is intended to operate for only a predetermined number of miles, e.g., 500,000 miles, the sensors 408 (and/or the processing device 404) can be used to store an accumulated number of miles for which the component 406 has been used. In some cases, the component 406 may not be used or exposed to certain parameters 414 during each route taken by the vehicle 402. Therefore, the sensors 408 allow for accurate gathering of data for actual use of the components 406, as well as exposure of the components 406 to certain conditions or parameters 414 which affect their lifetime. The accumulated exposure 416 of the components 406 can therefore be determined using the same model as the qualification of the component based on initial testing standards, but based on real-time data that allows for a more accurate determination of the lifetime of the component 406.

The processing device 404 can execute a lifetime model 424 that receives as input the sensor data 410, the parameters 414, the manufacturer specifications 422, and the accumulated exposure 416, to output an estimated or remaining component lifetime 426. The estimated lifetime 426 can be output in the form of, e.g., days, months, or years to failure. In some embodiments, the estimated lifetime 426 can be output in the form of, e.g., the mission quantity remaining. For example, the system 400 can indicate that the vehicle 402 is capable of operating three more missions before the component 406 will need to be replaced. In some embodiments, the component lifetime 426 can be determined for the accumulated exposure 416 of each individual parameter 414. For example, the component lifetime 416 based on only the temperature exposure can be determined. In some embodiments, the component lifetime 426 can be determined for the accumulated exposure 416 of a combination of two or more parameters 414. For example, the component lifetime 416 based on a combination of temperature and humidity exposure can be determined. In some embodiments, failure of one or more components 406 can occur before the individual components reach their lifetime (or failure) thresholds and the system 400 can consider this combination of usage data to assist with replacement of the affected components 406 in a timely manner. In some embodiments, historical data 430 collected by the sensors 408, as well as failure data for the components 406, can be used to estimate the lifetime 426 for the components 406.

In some embodiments, the lifetime models 426 are separated for each parameter 414, except for humidity and temperature which are used as input variables for the model 426. In general, the models 426 can be based on equations used in the industry to determine the threshold or expected component lifetime 428 by manufacturer specification, based on industry qualification standards, and/or by internal life testing and analysis to develop acceleration models, which is applied to components 406 of the same type/model without considering or only assuming the on-road usage and exposure of the components 406. The assumed on-road usage and exposure of the components 406 can differ from the accumulated, actual usage and exposure. The system 400 relies on the sensors 408 to detect the usage and/or exposure of the components 406 on the vehicle 402, can relies on the lifetime models 426 using equations from the industry to obtain a more accurate determination of the estimated or remaining component lifetime 426. In particular, rather than generally providing a lifetime 428 for all similar types of components 406, the system 400 allows for vehicle-specific determinations of component lifetime 426 to be estimated. Because each vehicle 402 can travel along different routes or be exposed to different environments, the component lifetime 426 can differ per vehicle 402. The system 400 therefore provides for a more accurate determination of lifetime 426, allowing for greater efficiency in maintenance.

In some embodiments, the system 400 need not use the same equations as manufacturers for the models 426. In some embodiments, lifetime limits can be set by sub-component manufacturers (e.g., pumps rated for 1,000 cycles, diode rated for 3A forward current at 175C Tj and tested for 1,000 hours, or the like). In some embodiments, typical industry acceleration equations in a test-to-success qualification approach (common in the automotive industry) can be used. In some embodiments, any component can have a lifetime model associated with it by running a test-to-failure reliability test, with this model being custom and proprietary to the company involved and usually specific to the exact unit/technology the test was completed on. In some embodiments, a temperature induced drift or stability model can be used by the system 400.

In some embodiments, the humidity exposure model can be based on, e.g., the Lawson model, Peck's model, or the like. For, example, if Peck's model is used, model can be empirically derived from a large number of different life studies as shown in Equation 1:

$${t}_{f} = {A ( R H )}^{- n} {e}^{\frac{{E}_{a}}{k T}} \qquad ( 1 )$$

where t_{f} is the time of failure, A is a constant dependent on the materials, process, and conditions, RH is relative humidity, n is a constant, Eₐ is the activation energy, k is Boltzmann's constant (8.617×10⁻⁵ eV/K), and T is temperature in Kelvin. In some embodiments, t_{f} can be replaced with mean time between failure (MTBF). An acceleration factor or model can be determined by using Peck's relationship as a ratio of test conditions over use conditions, eliminating the constant A due to cancelation to reach the ratio of Equation 2:

$$A F = {( \frac{R {H}_{u s e}}{R {H}_{t}} )}^{- n} exp [ \frac{{E}_{a}}{k} ( \frac{1}{{T}_{use}} - \frac{1}{{T}_{t}} ) ] \qquad ( 2 )$$

where AF is the acceleration factor (or the number of times one can multiple the test), subscript t indicates that the Tₜ is the test temperature in test data (in Kelvin), and subscript use indicates that Tᵤₛₑ is the use temperature in (in Kelvin),.

In some embodiments, the model 426 can be based on the Arrhenius acceleration equation, which is used across reliability tests in many industries (e.g., common in ICs and individual transistors). The Arrhenius acceleration equation can be used in electronic assembly reliability testing with the assumption that the main temperature wear out failures will occur in the individual ICs and transistors. Although this information is from the Daimler Truck standard MBN10306, the same can be used with ISO standards. For example, Equation 3 can be used for lifetime calculation on steady state elevated temperature. For each temperature from T_{field,At} to T_{field} of the temperature distribution profile, an acceleration factor A_{T,1} . . . . A_{T,n} can be calculated with the model 426 on the basis of Equation 3:

$${A}_{T , i} = {e}^{[ - ( \frac{{E}_{A}}{k} ) \times ( \frac{1}{{T}_{test} + 273.15} - \frac{1}{{T}_{field , i} + 273.15} ) ]} \qquad ( 3 )$$

where A_{T,i} is the acceleration factor of the Arrhenius model, E_{A} is the activation energy E_{A}=0.45 eV (which varies for different components and/or silicon technologies), k is the Boltzmann constant (k=8.617×10⁻⁵ eV/K), Tₜₑₛₜ is the test temperature in Celsius (normally Tₘₐₓ), T_{field,i} is the field temperature in Celsius according to temperature distribution profile based on mission profile, and −273.15° C. is the absolute zero of the temperature.

For temperature cycle stress, the model 426 can be the Coffin Mason model. In particular, the temperature cycle endurance test is based on the average temperature change of the component in the field ΔT_{field} and the number of temperature cycles during service life in the field N_{TempCyclesfield}. Typically, two temperature changes per day can be assumed for the number of temperature cycles in the field. This results in Equation 4:

$${N}_{TempCyclesfield} = 2 \times 365 \times 15 ( years ) = 10 , 950 cycles \qquad ( 4 )$$

Depending on the average temperature change in the field, the acceleration factor of the Coffin Manson model can be calculated from Equation 5:

$${A}_{CM} = {( \frac{Δ {T}_{t e s t}}{Δ {T}_{field}} )}^{C} \qquad ( 5 )$$

where A_{CM} is the acceleration factor of the Coffin Mason model, ΔTₜₑₛₜ is the temperature difference during a test cycle (ΔTₜₑₛₜ=Tₘₐₓ−Tₘᵢₙ), ΔT_{field} is the average temperature difference of the component's ambient temperature at its installation location during its service life in the field, and C is the parameter of the Coffin Mason model (a fixed value of 2.5). The total number of test cycles can be calculated according to Equation 6:

$${N}_{test} = \frac{{N}_{TempCyclesfield}}{{A}_{CM}} \qquad ( 6 )$$

where Nₜₑₛₜ is the required number of test cycles, N_{TempCyclesfield} is the number of temperature cycles during service life in the field (per Equation 4), and A_{CM} is the acceleration factor of the Coffin Manson model (per Equation 5).

In some embodiments, for the model 426 for vibration can be from ISO-16750-3, with a ratio based on historical data from the industry. For example, for cars, 22 testing hours according to a specific profile can be equal to 4,400 hours of lifetime. As noted in the ISO-16750 standard, three distributions were chosen: (i) an engine speed distribution which has been published in SAE where 55 cars were investigated (70,000 km; 10,000 trips), (ii) a “severe” engine speed distribution that was recorded during temperature measurements with the aim to reach very high temperatures; therefore, the vehicles were driven in a very high engine speed range, and (iii) weighted distribution, consisting of distribution a) SAE publication=80%, and distribution b) severe=20%. This leads to a relevant distribution of 0.5% in the engine speed range from 0.9nₙₒₘᵢₙₐₗ to nₘₐₓ. Testing 22 hours along each axis is equal to approximately 4,400 hours of lifetime in the vehicle. With an average speed of 40 km/h, this represents a mileage of 176,000 km. Taking into account other lifetimes/mileages/min distributions, the test duration can be changed proportionally. Depending on the required lifetime and the required engine speed distribution, the result of the calculation can lead to long test duration. The recommended maximum test duration for practical reasons is 100 hours per axis. For most vibration environments, equivalent fatigue damage is easily accomplished within this duration. In general, for commercial vehicles, the fatigue limit is covered.

Based on the determined remaining or estimated component lifetime 426, the system 400 can take several actions. In some embodiments, the system 400 can gather the sensor data 410 in real time, but the determination of the estimated lifetime 426 can be executed before the vehicle 402 is to be used to determine if departure of the vehicle 402 is permitted or if replacement of a component 406 is needed. For example, if the component lifetime 426 is approaching an endpoint within a predetermined threshold relative to the expected lifetime 428, the system 400 can issue an alert 432 to the user/driver via the user interface 420, to the vehicle 402, and/or to mission control 418, indicating that a maintenance event is needed to replace the component. In some embodiments, the system 400 can automatically schedule a maintenance event to ensure the component 406 is timely replaced before the estimated lifetime 426.

In some embodiments, the system 400 can operate the threshold determination as a risk-based decision. In some embodiments, the system 400 can issue the alert 432 or schedule the maintenance event at about 95% of time to the threshold, or the like. For components that are not critical to driving functions, such as the AC compressor, a decision may be made to temporarily ignore the 100% life threshold because an oil change is scheduled to be performing in 4,000 miles and the AC compressor can be replaced in a single trip to the maintenance hub. As a further example, for an O₂ sensor and failure mode of carbon build-up, the system 400 can schedule a cleaning event consistently at about 80% of the life threshold to ensure a margin to time with other maintenance actions/trips to the hub. For more critical components that would cause a severe in-road failure, such as the transmission, action can be taken at a level of about 90% relative to the threshold. In some embodiments, the system 400 can run the component to failure past its lifetime threshold. In some embodiments, a refurbishment can be scheduled to replace wearing subcomponents. In some embodiments, an electrical, mechanical or visual inspection can be completed, and a risk-based decision can be made to run the component to failure past its lifetime threshold.

In some embodiments, the system 400 can compare the estimated lifetime 426 to a planned mission route 434 scheduled for the vehicle 402. For example, if the vehicle 402 is scheduled to depart on a short trip which would still allow the component 406 to function within the estimated lifetime 426, the vehicle 402 can be permitted to depart on the trip to complete the mission route 434 and the maintenance event can be scheduled for after completion of the mission route 434. However, if the mission route 434 is determined to extend beyond the estimated lifetime 426, the maintenance event can be scheduled for before the mission route 434 or the mission route 434 departure can be postponed until the vehicle 402 is properly maintained. In some embodiments, the system 400 can adjust the mission route 434 or generates a new mission route 434 that would allow the component 406 to operate within the estimated lifetime 426 during the mission route 434.

Thus, rather than simply replacing the component 406 based on the industry or manufacturer lifetime 428, the system 400 can be used to monitor the actual usage of the component 406 and estimate or predict a more accurate lifetime 426 based on vehicle-specific usage. In particular, the lifetime calculation is dynamic for each vehicle 402 based on its specific usage and environmental exposure. Rather than a general determination of lifetime (based solely on operating hours and the original acceleration model that assumed an operating profile), the lifetime value is determined based on data collected on board of the vehicle itself, ensuring a more accurate result. In some instances, the lifetime 426 can be greater than the lifetime 428 (e.g., longer period of time to reach the accumulated exposure 416 for failure based on smaller exposure frequency). In some instances, the lifetime 426 can be smaller than the lifetime 428 (e.g., shorter period of time to reach the accumulated exposure 416 for failure based on greater exposure frequency).

In some embodiments, the sensor data 410 can be useful in generating usage details 436 for each of the component 406. The usage details 436 can indicate whether the component 406 was used according to manufacturer specifications 422, e.g., in the intended environment, in the intended conditions, or the like. For example, if the component 406 fails prematurely, the usage details 436 can be used as a data log to prove that the component 406 was properly used and replacement under a manufacturer warranty is needed.

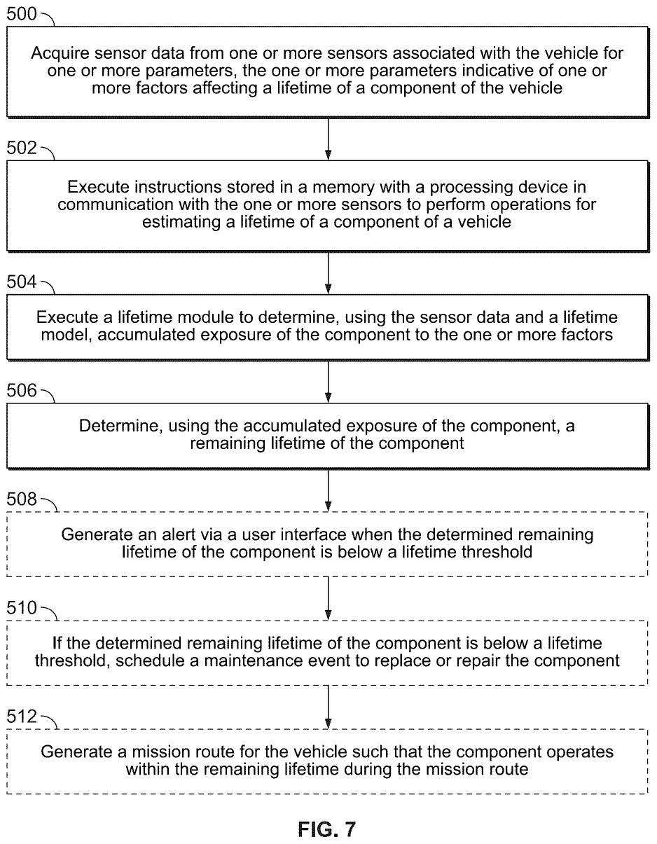

FIG. 7 is a flowchart of a method of component lifetime estimation by the exemplary system 400 discussed herein. At 500, sensor data is acquired from one or more sensors associated with the vehicle for one or more parameters. The parameters are indicative of one or more factors affecting a lifetime of a component of the vehicle. At 502, instructions stored in a memory are executed with a processing device in communication with the sensors to perform operations for estimating a lifetime of a component of the vehicle.

At 504, a lifetime module is executed by a processing device of the vehicle to determine, using the sensor data and a lifetime model, accumulated exposure of the component to the one or more factors. At 506, using the accumulated exposure of the component, a remaining lifetime of the component is determined. At 508, the system can optionally generate an alert via a user interface when the determined remaining lifetime of the component is below a lifetime threshold. At 510, if the determined remaining lifetime of the component is below a lifetime threshold, the system can schedule a maintenance event to replace or repair the component. At 512, the system can generate a mission route for the vehicle such that the component operates within the remaining lifetime during the mission route.

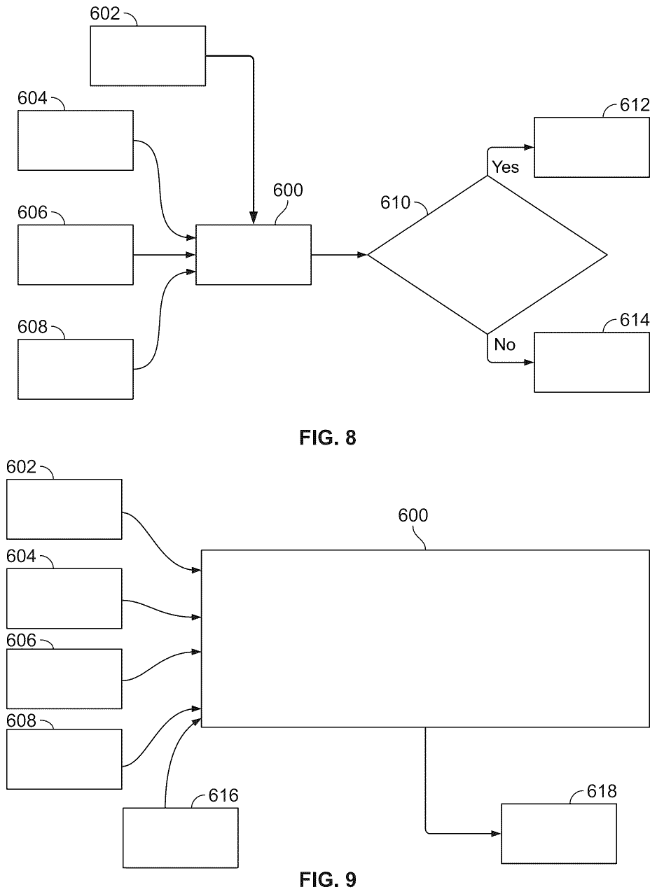

FIG. 8 is a flowchart illustrating execution of a dynamic lifetime module or model 600 by the exemplary system (e.g., system 400). The model 600 can receive as input data from one or more sensors, such as data relating to the odometer 602, the power cycle count 604, the temperature 606, the accelerometer 608, or the like. In some embodiments, vibration sensor discussed herein can be, e.g., the accelerometer 608, a tri-axial accelerometer, or the like. In some embodiments, the input data can be from any of the sensors discussed herein, such as temperature sensors, humidity sensors, vibration sensors, perception sensors, UV radiation sensors, power cycle counters, encoders, Hall effect sensors, flow meters, revolution measuring sensors, combinations thereof, or the like. In some embodiments, the power cycle count 604 can remain or be deleted very time a power cycle occurs. A temperature delta occurs at the component (during heating up). Thus, if a unit is characterized, power cycles can be a proxy for ΔT minus any ambient diurnal temperature variation. In high power units, power cycles usually dominate the ΔT described in the Coffin-Mason model. The model 600 estimates the remaining lifetime for the component, and outputs this value to a processing device 610. The processing device 610 can be in the form of a mission planner, and can determine if sufficient lifetime is remaining for the component to allow the vehicle to complete a mission. If sufficient lifetime is remaining, the system can allow the vehicle to start its mission at 612. If insufficient lifetime is detected, the system can generate and schedule a maintenance action at 614 to replace the failing component. In some embodiments, actions other than replacement of the component can be taken, e.g., inspection of the component, refurbishment, leaving the component on until a later time when maintenance is scheduled, or the like.

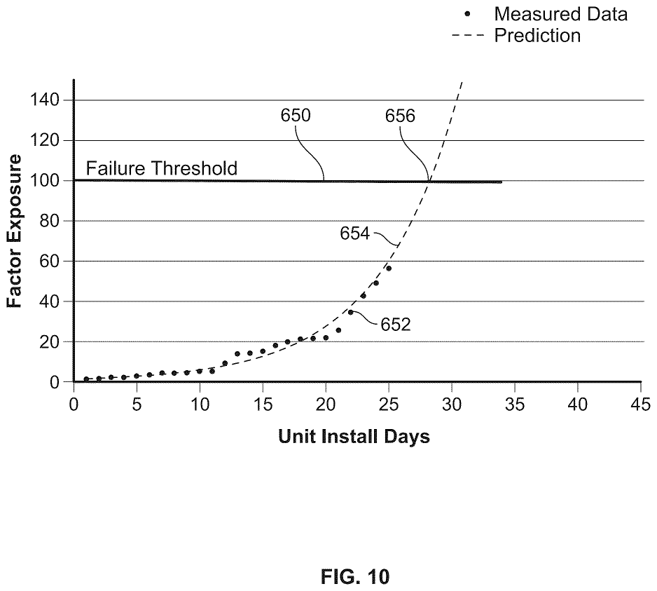

FIG. 9 is a flowchart illustrating execution of the dynamic lifetime module or model 600 of FIG. 8. However, in addition to the input factors illustrated in FIG. 8, the model 600 can receive as input sensor data relating to humidity 616 to estimate the lifetime 618 of the component.

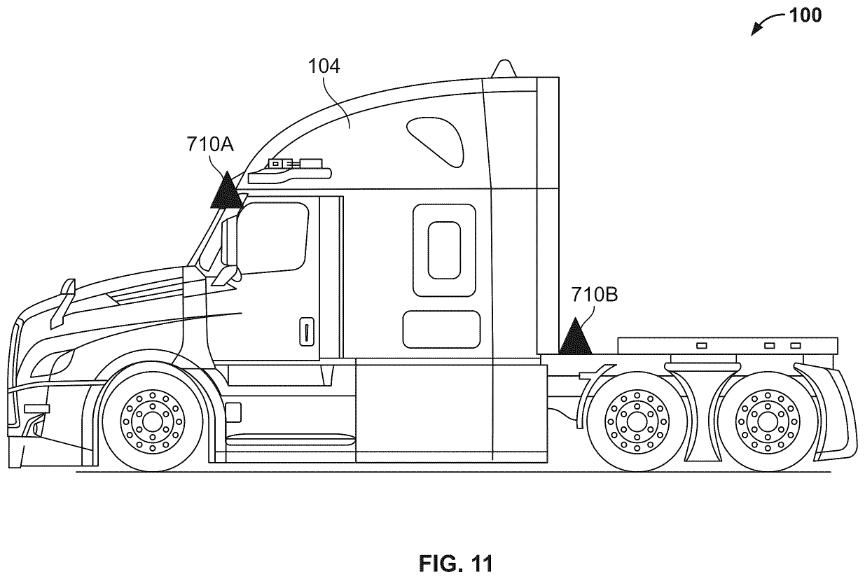

FIG. 10 is a chart illustrating accumulated factor exposure over time for a component as a non-limiting example of how sensor data is used by the exemplary system to estimate or predict the remaining lifetime for a component. The line 650 represents the lifetime (or failure) threshold for a single component of the vehicle, as determined by industry and/or manufacturer standards. While the manufacturer or industry can indicate that this threshold is expected to be reached within, e.g., 20 days, after installation and use of the component, the exemplary system can be used to estimate the actual lifetime of the component using real-time data from sensors on the vehicle.

In particular, data points 652 represent measured accumulated values for factor exposure for the component. It should be understood that the factor exposure can be for one or more factors, depending on the type of model being used for estimation of the component lifetime. The values for factor exposure are also only provided for example, and it should be understood that actual data would include a corresponding unit for the factor accumulation. A prediction line 654 can be generated based on the data points 652 obtained from the sensor data. The prediction line 654 provides an estimated day for when the lifetime/failure threshold will be reached based on actual data for usage and/or environment exposure of the component on the vehicle.

For example, the prediction line 654 estimates that failure point 656 will occur at about 28 days (as compared to the example of 20 days noted by the industry or manufacturer). Based on this data, the system would allow for continued usage of the component beyond the preset 20 days, with a decision to replace the component before the estimated 28-day failure point. The system can therefore be used to optimize usage of the component, maximizing use of the component rather than prematurely replacing the component based on industry or manufacturer standards. Reduction in overall maintenance costs for the vehicle can thereby be achieved.

Accurate and/or real time, or near real time, monitoring of the exposure of a component, e.g., a vehicle component, to usage and/or environmental factors allows for accurate estimation or prediction of the remaining lifetime of the component in real time or near real time. As discussed above, a preset lifetime determined based on static accelerated test profiles and used for separate or all components of the same type and/or same model may not accurately reflect the dynamic lifetime of each component. For instance, separate components can be installed in separate vehicles and undergo different environmental and/or road conditions over time. Even if separate components of the same type and/or same model are installed in the same vehicle, they may still undergo different conditions for being located at different positions within the vehicle.

Inaccurate estimation or prediction of the remaining lifetime of a component can lead to early replacement or early maintenance of the component, or can lead to a failure of the component while the component is in use in the vehicle. Early replacement of the component implies that the component is used up to its full lifetime. Also, early maintenance of the component can lead to more maintenance events than needed over the operational lifetime of the component. Both cases imply inefficient use of the component. Failure of the component while in use can lead to failure of other related components, e.g., components connected to the failing component, or may result in a high risk for an accident. For instance, sudden failure of a LiDAR 212 or a RADAR 210 of the vehicle 100 can significantly affect the automatic autonomous driving system or the autonomy level of the vehicle 100.

One of the factors or conditions that affects vehicle components is vibration or shock, e.g., caused by road roughness and/or engine vibrations. In particular, vibrations can have accumulating negative impact on electrical components, and as such can lead to accumulating or increasing probability of failure over the duration of stress experienced. For instance, vibrations can cause mechanical stress on an electrical component, resonance in the electrical component, and/or friction between electrical components or elements thereof. Mechanical stress can cause deformation or even breakage of the electrical component. In some instances, vibrations can degrade electrical connections, e.g., soldering, or the like, within the electrical component. Friction between the electrical components can cause wear and tear, e.g., connector fretting or fretting corrosion, and friction can cause or lead to overheating. Vibration or friction can also cause change of contact for electric elements, such as contact change for connector pins. Vibrations can also cause electromagnetic interference (EMI), e.g., in radar antennas, leading to degradation of electric or electromagnetic signals associated with some components of the vehicle 100. These factors individually or in combination can cause component degradation over time, therefore reducing the component lifespan.

In general, electrical components, mechanical components and/or electromechanical components can be affected by vibrations or shocks. For instance, components that can degrade over time due to vibrations or shocks can include LiDARs 212, RADARs 210, optical sensors, pressure sensors, cameras, other types of sensors, controllers, engine control units (ECUs), lighting systems, alternators, starters, direct current (DC) converters, electric motors, battery packs, wireless communication devices, media systems, cooling fans, and/or patch antenna, among other components.

The vibrations or shocks experienced by each component can depend on the location of the component within the vehicle. For example, a component installed in or on the cabin 104 can experience lower intensity vibrations compared to another component installed at the vehicle chassis, at or close to the engine, or close to one of the wheels 106 or 112. However, the number and locations of vibration sensors, e.g., accelerometers, within the vehicle 100 is usually limited and do not span all the locations of the components to be accurately monitored. As such, location-specific accelerometer readings for each of the potentially affected components of the vehicle 100 are not available. In other words, installed vibration sensors may not be close enough to a monitored component to accurately record vibrations experienced by the component.

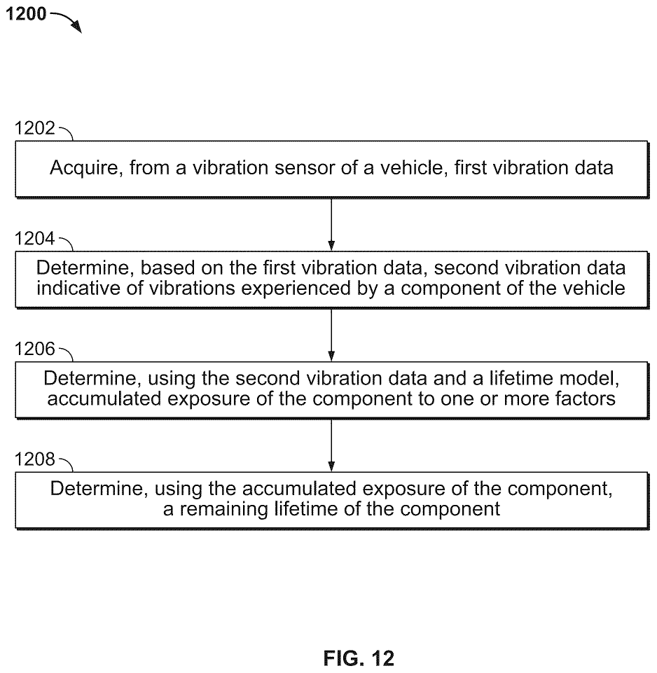

Referring now to FIG. 11, a schematic side view of the autonomous vehicle 100 is shown. The autonomous vehicle 100 is shown to include a vibration sensor (or accelerometer) 710A installed within or on the cabin 104 and another vibration sensor 710B located or installed on or at the chassis of the autonomous vehicle 100. In some implementations, the autonomous vehicle 100 may include the vibration sensor 710A but not the vibration sensor 710B, or may include the vibration sensor 710B but not the vibration sensor 710A. In some implementations, a set of vibrations sensors can be installed at defined positions, e.g., in or on the cabin, at chassis and/or engine mounted, to enable estimation or modeling of vibrations at various components of the vehicle 100.

In a case where the autonomous vehicle 100 includes the vibration sensor 710A but not the vibration sensor 700B, the vibration sensor 710A may not accurately measure vibrations to which a component installed at the chassis is exposed. Similarly, if the autonomous vehicle 100 includes the vibration sensor 710B but not the vibration sensor 700A, the vibration sensor 710B may not accurately measure vibrations to which a component installed at the cabin 104 is exposed. In general, vehicles or autonomous vehicles are designed and manufactured with a defined set of sensors 110 installed at defined locations within the vehicles. For instance, a set of vibration sensors, e.g., sensors 710A and 710B, and/or other types of sensors can be installed to provide holistic measurements of the vehicle chassis and cab to allow extending v to additional components. As such, there is no need to be install a vibration sensor at every component location and the installed vibration sensors, e.g., vibration sensors 710A and 710B, used for nominal autonomous driving can also be used for the lifetime model calculations. Typically, the number of vibration sensors as well as other types of sensors installed in a vehicle can be limited and the corresponding sensor locations do not match locations of components to be monitored.

Systems and methods described herein allow for accurate monitoring and determination of accumulated fatigue or damage to components of a vehicle in real time or near real time, and accurate tracking or estimation of the remaining lifetime of the components. In particular, the systems and methods described herein enable compensating for the mismatch between the factors or conditions experienced by a component of a vehicle and measurements of such factors or conditions acquired by one or more sensors located apart or at a distance from the respective components.

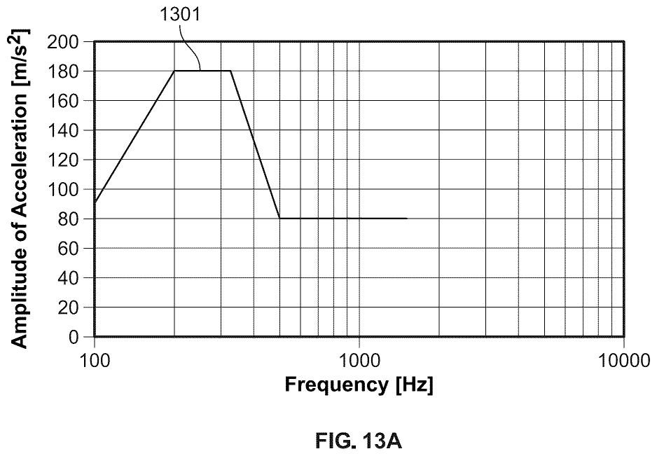

Referring now to FIG. 12, a flow chart of a method 1200 for monitoring one or more components of a vehicle, according to an example embodiment of the current disclosure. In brief overview, the method 1200 can include acquiring, from a vibration sensor of the vehicle, first vibration data (1202), determining, based on the first vibration data, second vibration data indicative of vibrations experienced by a component of the vehicle (1204), determining, using the second vibration data and a lifetime model, accumulated exposure of the component to one or more factors (1206), and determining, using the accumulated exposure of the component, a remaining lifetime value of the component (1208).

The method 1200 can be implemented by the system 400 of FIG. 6 or components thereof. In some implementations, the database(s) 412 or components thereof can be implemented onboard the vehicle 402, in the mission control 418 or in a remote computer system, e.g., the cloud. The system 400 can monitor the component 406 of the vehicle 402, e.g., with regard to exposure to vibrations and/or other factors, to determine or track remaining lifetime of the component 406.

During a testing phase, e.g., according to static accelerated test profiles, additional vibration sensors can be installed at or in the vicinity of components 406 to be monitored in addition to already existing vibration sensors. For example, referring back to FIG. 11, the autonomous vehicle 100 may include only vibration sensor 710A and vibration sensor 710B can be added or installed in the vicinity or at the component 406 to be monitored. The installation of the additional vibration sensors can be used to record vibration data at the component 406 of interest. For instance, when both sensors 710A and 710B are installed in the vehicle 100 and none of them is located at the component 406, vibration data can be recorded at the testing or training phase by the vibration sensors 710A and 710B and a vibration sensor installed (e.g., for training/testing purposes) at or in the vicinity of the components 406. This allows for assessment and calibration models described herein to transform vibration data measured at 710A and 710B to the vibration data measured at the component 406. Systems and methods described herein can use the test vibration data from both vibration sensors 710A and 710B to compensate for the mismatch of vibration data recorded by the vibration sensor 710A during deployment and the vibrations experienced by the monitored component 406. In some instances, this testing phase can be used to train the system 400 or components thereof to accurately estimate the vibrations or corresponding damage experienced by the monitored component 406. For example, vibration data recorded during the testing or training phase can be used to train or construct a machine learning model, a static model, a statistical model or a combination thereof.

Referring back to FIG. 12, the method 1200 can include one or more processors, e.g., processing device 404, acquiring, from a vibration sensor or acceleration sensor of the vehicle, first vibration data (1202). During a deployment phase when the vehicle, e.g., autonomous vehicle 100, is being used, a vibration sensor integrated in the vehicle, e.g., vibration sensor 710A, can record vibration data over one or more time segments. For instance, the vibration sensor 710A can record vibration data on a continuous or near continuous basis. In some implementations, the vibration sensor 710A can measure or record vibration at a sampling frequency of about 60 Hz (e.g., between 50 Hz and 70 Hz), 100 Hz (e.g., between 90 Hz and 110 Hz), 120 Hz (e.g., between 110 Hz and 130 Hz), 200 Hz (e.g., between 180 Hz and 220 Hz), or some other frequency. The vibration sensor 710A can transmit vibration measurements to the one or more processors in real time or near real time. As used herein vibration data or vibration measurements represent or include acceleration data or acceleration measurements. Also, in some embodiments, the vibration sensors include or can be acceleration sensors.

In some implementations, the method can include the one or more processors transforming the first vibration data from time domain to frequency domain. Transforming the vibration data to the frequency domain can include determining or computing a Fourier transform and/or a power spectral density of the vibration data acquired from the vibration sensor 710A. For instance, the one or more processors can compute the Fourier transform or the power spectral density for each segment of the acquired vibration data. Data segments can be defined based on a fixed or predefined length or time duration.

In some implementations, the one or more processors can apply a fast Fourier transform (FFT) to vibration samples recorded by one or more vibration sensors. The FFT represents the recorded vibration or acceleration data in terms of its spectral or frequency components. The FFT or PSD of the recorded vibration or acceleration data recorded over a time period can be viewed as representing a vibration profile in the frequency domain. For the component 406, the corresponding vibration profile in the frequency domain can be the FFT or PSD of the estimated vibration or acceleration data representing an vibrations experienced by the component 406. During the testing phase, vibration or acceleration data recorded at the component 406 can be used to determine or compute a test vibration profile, in the frequency domain, of the component 406. In some implementations, the one or more processors can determine or computer a test vibration profile of the sensor, e.g., sensor 710, using testing vibration data recorded by the sensor 710 during the testing phase.

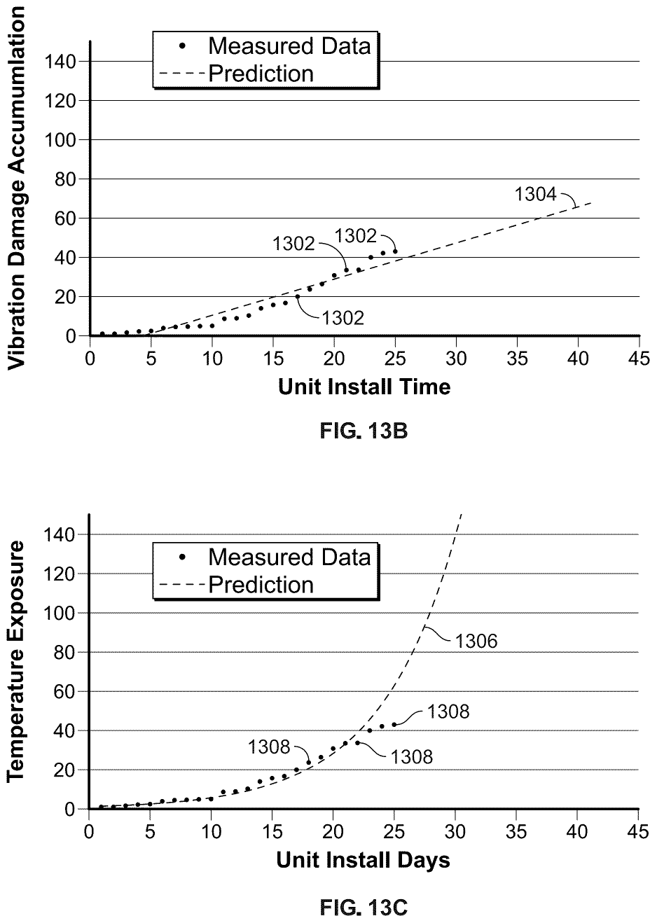

Referring now to FIG. 13A, a plot 1301 representing an example test vibration profile of a component is shown, according to an example embodiment of the current disclosure. The x-axis represents frequency while the y-axis represents the amplitude of acceleration recorded over the testing period per frequency. The plot 1301 can be computed or determined by applying FFT to the acceleration data recorded at the component 406 during the testing phase. In some implementations, PSD can be used, e.g., instead of FFT.

The method 1200 can include determining, based on the first vibration data, second vibration data indicative of vibrations experienced by the component 406 of the vehicle 402 (1204). The component 406 can be at a different location in the vehicle 402 compared to the vibration sensor. It is to be note that the vehicle 402 can include the vibration sensor 710A installed or integrated therein but not the vibration sensor 710B. In some implementations, the vibration sensor 710B can be installed during the testing or training phase, for generating testing or training data, at the component 406. The one or more processors, e.g., processing device 404, can use the acquired vibration data and test vibration recorded by both sensors 710A and 710B during the testing phase to estimate or determine the second vibration data indicative of the vibrations experienced by the component 406 of the vehicle 402. For instance, the one or more processors can use the test vibration recorded by both sensors 710A and 710B during the testing phase to determine or estimate the discrepancy or mismatch between the vibrations experienced or measured by the vibration sensor 710A and the vibrations to which the component 406 was exposed.

In some implementations, the one or more processors can determine or estimate the vibration discrepancies or differences between the vibration sensor 710A and the monitored component 406 based on a frequency domain analysis or a frequency domain model. For instance, the test vibration data recoded by the sensor 710A and at the component 406, during the testing or training phase, can be transformed into the frequency domain, e.g., using the Fourier transform or power spectral density. Discrepancies or differences between the data sets associated with the vibration sensor 710A and the component 406 can be frequency dependent. For example, the difference between the power spectral densities of the test vibration data sets for the vibration sensor 710A and the component 406 can be computed and stored in a memory, e.g., memory 303, 304 or 306. The one or more processors can use the difference between the power spectral densities of the test data sets and the power spectral density of vibration data recorded by the vibration sensor 710A to determine or estimate the power spectral density of the component 406, during a deployment phase. In some implementations, a power gain profile, in the frequency domain, can be computed based on the power spectral densities of the test vibration data sets for the vibration sensors 710A and the component 406, during testing or training phase. The one or more processors can use the power gain profile to determine or estimate the power spectral density of the component 406, during the deployment phase. In other words, the one or more processors can determine the power gain to be applied to the power spectral density of the vibration data acquired at 1202 at each frequency.

In some implementations, the one or more processors can use the test vibration profile of the sensor and the test vibration profile of the component 406, computed using FFT, to determine, e.g., at each frequency, the discrepancy between the test vibration profile of the component 406 and the test vibration profile of the sensor. In some implementations, the one or more processors can determine the discrepancy at each frequency as a corresponding multiplicative factor. For example, the one or more processors can adjust the FFT of the first vibration data recorded at the sensor according to the determined multiplicative factors to estimate or determine the FFT of the second vibration data corresponding to the component 406.

In some implementations, the one or more processors can employ a machine learning (ML) model, a static model, a statistical model or a combination thereof to determine or estimate vibration or acceleration data at the component 406 based on vibration or acceleration data recorded by one or more vibrations sensors, e.g., vibration sensor 710A, installed in the vehicle. For example, vibration data recorded by the vibrations sensor 710A and vibration data recorded at the component 406, during the testing or training phase, can be used to train a machine learning model or to determine or construct a static mathematical model or a statistical model for estimating or determining, in the deployment phase, vibration or acceleration data at the component 406 based on recorded vibration or acceleration data at the installed vibrations sensor(s), e.g., vibration sensor 710A.

The method 1200 can include determining, using the second vibration data and the lifetime model 424, accumulated exposure of the component 406 to one or more factors (1206). The one or more processors can use the lifetime model 424 or a damage model to determine accumulated vibration damage. In some embodiments, the accumulated vibration damage can be based on exposure of the component 406 to any type of vibration magnitudes. In some embodiments, the accumulated vibration damage can be determined based on exposure of the component 406 to vibrations or accelerations with magnitudes exceeding a certain threshold and/or vibrations within a certain frequency range. For instance, the one or more processors can determine accumulated exposure of the component 406 to vibrations or accelerations deemed or expected to affect the lifetime of the component 406. The one or more processors can filter the vibration data acquired at 1202 and use the filtered vibration data to determine or compute the accumulated vibration damage. In some implementations, the accumulated vibration damage can be determined based on whether the component 406 was exposed to a vibration or acceleration with an amplitude exceeding a defined threshold. For example, a single exposure to a vibration or acceleration exceeding the defined threshold may be sufficient to render the component 406 deficient. In some implementations, the one or more processors can use a trained machine learning model to compute or determine the accumulated vibration damage. In some implementations, the lifetime model can include an ISO-16750 standard model. For instance, the one or more processors can use the ISO-16750 standard model and the second vibration data to determine the accumulated vibration damage.

In some implementations, the one or more processors can determine the accumulated exposure of the component 406 in the frequency domain. For instance, the one or more processors can determine the accumulated exposure per frequency using the vibration profile, in frequency domain, of the estimated vibration data of the component throughout the deployment phase. For example, the one or more processors can estimate, for time segment, the FFT of the acceleration data of the component 406 and sum the FFTs for different time segments to determine a current estimate of deployment vibration profile of the component 406 reflecting an estimate of the accumulated acceleration amplitude per frequency experienced by the component 406 so far after deployment of the component 406.

Referring now to FIG. 13B, a plot of vibration damage accumulation is shown, according to an example embodiment of the current disclosure. The data points 1302 represent the accumulated vibration damage determined based on the second vibration data indicative of the vibrations experienced by the component 406. The line 1304 represents a prediction line that is generated based on the data points 1302. The prediction line 1304 can be used to determine or estimate when a threshold for accumulated vibration damage will be reached.

While method 1200 is described in relation to vibration and vibration sensors, a similar approach can be used for other factors, such as temperature and/or humidity, among other factors. For instance, the temperature sensor 218 of the vehicle may be spaced apart from the component 406 being monitored for accumulated damage and/or remaining lifetime. As such, temperature recorded by the temperature sensor 218 may not accurately reflect the temperature at the monitored component 406. In some embodiments, the method 1200 can be used to determine the estimated accumulation for two or more factors, e.g., a combination of accumulated vibration damage, accumulated temperature damage and/or accumulated humidity damage, among other factors. In some implementations, the one or more processors can employ a trained machine learning model to determine or estimate accumulation of one or more damage or fatigue factors. The machine learning model can be trained using training data acquired during the testing and/or training phase.

FIG. 13C depicts a plot of temperature damage accumulation, according to an example embodiment of the current disclosure. The line 1306 represents the accumulated temperature damage estimated or predicted using test temperature data points 1308 (and in some instances, a static test profile). The data points 1308 represent the accumulated temperature damage determined based on compensated temperature measurement indicative of the temperature experienced by the component 406.

Referring back to FIG. 12, the method 1200 can include determining, using the accumulated exposure of the component 406, a remaining lifetime value of the component 406 (1208). The one or more processors can use a prediction model to determine the remaining life of the component 406. The prediction model can include a line fitting approach, a curve fitting approach, a trained machine learning model or some other model. For instance, the lifetime model can include a prediction model used to predict or estimate the remaining life of the component 406. The prediction model can use the accumulated vibration damage as input and provide an estimate of the remaining lifetime as output. In some implementations, the prediction model can receive a combination of accumulated vibration damage, accumulated temperature damage and/or accumulated humidity damage, among other factors, as input and provide an estimate of the remaining lifetime as output.

The one or more processors can take one or more actions responsive to the determined remaining lifetime of the component 406. For instance, the one or more processors can perform one of the actions described above in relation with method elements 508 to 512 of FIG. 7. In some implementations, the one or more processors can perform at least one of causing an indication of the remaining lifetime value to be displayed on a dashboard of the vehicle, or providing the indication of the remaining lifetime value to a remote computer device. In some implementations, the one or more processors can determine that the remaining lifetime value is smaller than a threshold value, and generate an alert signal responsive to determining that the lifetime value is smaller than the threshold value. In such embodiments, the alert can be used to recommend or automatically schedule a maintenance event to ensure that the component is replaced prior to commencing a mission in which the component is expected to fail.

In some implementations, the one or more processors can determine the remaining lifetime in the frequency domain. For example, the one or more processors can compare the current estimate of the deployment vibration profile of the component 406 to the corresponding test vibration profile of the component 406. At each frequency or frequency bin, the one or more processor can compare the amplitude of accumulated acceleration or accumulated PSD during the deployment phase (from the current estimate of the deployment vibration profile of the component 406) to the acceleration amplitude or PSD amplitude at the same frequency in the test vibration profile of the component. In other words, the one or more processors can determine or estimate the remaining lifetime per frequency.

In some implementations, the one or more processors can determine the remaining lifetime of the component 406 as the minimum remaining lifetime per frequency (e.g., the smallest remaining lifetime for any of the frequency bins). For example, the one or more processors can make a deployment decision to replace the component 406 based on or responsive to the first frequency to reach the respective mission life (e.g., reach the test acceleration or PSD at that frequency). In some implementations, the one or more processor can determine to replace the component 406 upon the accumulated deployment acceleration amplitudes (or accumulated PSDs) at a defined number of frequency bins (e.g., in plot 1301 of FIG. 13A) exceed the corresponding test acceleration amplitudes (or corresponding test PSDs) at the same frequency bins. For example, referring back to FIG. 13A, if the accumulated deployment acceleration at frequency 300 Hz is determined to be equal to be 162 m/s², the one or more processors can determine that the remaining lifetime for the frequency 300 Hz is (180-162)/180, which is equal to 10% of the total mission life or 10% of the total lifetime (assuming that the accumulated acceleration is a linear function of frequency). In some implementations, the accumulated acceleration (or accumulated exposure) may not be a linear function in terms of frequency.

In some implementations, the one or more processors can determine one or more thresholds, e.g., based on the test vibration profile of the component and determine the remaining lifetime based on the current deployment vibration profile of the component 406 and the one or more thresholds. The remaining lifetime can be determined based on a single frequency bin, multiple frequency bins or a function of accumulated deployment acceleration amplitudes (or PSDs) for a plurality of bins. In some implementations, the one or more processors can use a trained machine learning model, test vibration profile of the component 406 and the current deployment vibration profile of the component 406 to determine the remaining lifetime.

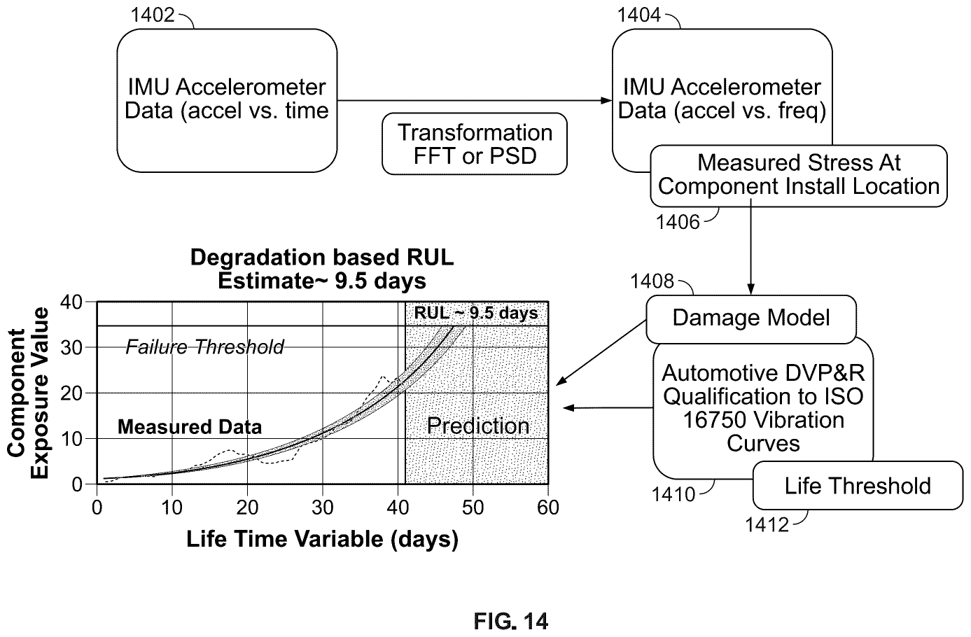

Referring now to FIG. 14, a flow diagram depicting an example implementations of the method 1200 is shown, according to example embodiments of the current disclosure. Vibration data 1402 acquired by a vibration sensor, e.g., vibration sensor 710A, can be transformed to frequency domain to compute or generate frequency-domain vibration data 1404. The frequency-domain vibration data 1404 can be used to determine or estimate vibration data 1406 at the component 406 as described above in relation with 1204 of FIG. 12. The estimated vibration data 1406 at the component 406 can be used to determine accumulated damage 1408, e.g., as described above in relation with step 1206 of FIG. 12. The one or more processors can use the accumulated damage 1408 and ISO-16750 standard model 1410 to predict the remaining lifetime of the component 406. The one or more processors can use a lifetime threshold 1412 to determine or estimate the remaining lifetime of the component 406.

In some implementations, field data recorded after launching or during the deployment phase of the system 400 and/or components thereof can be used to re-train or calibrate the lifetime model 424 and/or other models described herein, or calibrate the failure threshold(s) and/or any other thresholds.

In some implementations, the methods described herein can be implemented by a system integrated onboard the vehicle. In some implementations, the methods described herein can be implemented by a system remote from the vehicle. For example, the system can be implemented in the cloud and can receive sensor measurements from vehicle sensors via a telecommunication network.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for estimating a lifetime of a component of a vehicle, the system comprising:
one or more sensors associated with the vehicle; and
a processing device in communication with the one or more sensors, wherein the processing device is configured to execute instructions stored in a memory to perform operations comprising:
acquiring sensor data from the one or more sensors for one or more parameters, the one or more parameters indicative of one or more factors affecting a lifetime of a component of the vehicle;
executing a lifetime module to determine, using the sensor data and a lifetime model, accumulated exposure of the component to the one or more factors; and
determining, using the accumulated exposure of the component, a remaining lifetime of the component.

2. The system of claim 1, wherein the vehicle is an autonomous vehicle.

3. The system of claim 1, wherein the vehicle is a semi-autonomous vehicle or a non-autonomous vehicle.

4. The system of claim 1, wherein the one or more sensors include a thermostat to measure temperature.

5. The system of claim 1, wherein the one or more sensors include a vibration sensor to measure vehicle vibration.

6. The system of claim 1, wherein the one or more sensors include an odometer to measure vehicle mileage.

7. The system of claim 1, wherein the one or more sensors include a humidity sensor to measure humidity.

8. The system of claim 1, wherein the one or more parameters include temperature, vehicle vibration, vehicle mileage, and/or humidity.

9. The system of claim 1, wherein the component includes at least one of a camera, a vehicle sensor, light detection and ranging (LiDAR), and/or radio detection and ranging (RADAR).

10. The system of claim 1, wherein the one or more sensors are configured to generate the sensor data in real-time.

11. The system of claim 1, wherein the one or more sensors are configured to generate the sensor data in predetermined time intervals.

12. The system of claim 1, wherein the component is an electric device associated with the vehicle.

13. The system of claim 1, wherein the operations comprise generating an alert via a user interface when the determined remaining lifetime of the component is below a lifetime threshold.

14. The system of claim 1, wherein if the determined remaining lifetime of the component is below a lifetime threshold, the operations comprise scheduling a maintenance event to replace or repair the component.

15. The system of claim 1, wherein the operations comprise generating a mission route for the vehicle such that the component operates within the remaining lifetime during the mission route.

16. The system of claim 1, wherein the lifetime model includes an ISO-16750 standard model.

17. The system of claim 1, wherein the lifetime model is a prediction model.

18. The system of claim 1, wherein the operations comprise electronically storing the sensor data in a database, the sensor data indicative of environmental and operational standards in which the component was used with the vehicle.

19. A computer-implemented method for estimating a lifetime of a component of a vehicle, the computer-implemented method comprising:
acquiring sensor data from one or more sensors associated with the vehicle for one or more parameters, the one or more parameters indicative of one or more factors affecting a lifetime of a component of the vehicle; and
executing instructions stored in a memory with a processing device in communication with the one or more sensors to perform operations comprising:
executing a lifetime module to determine, using the sensor data and a lifetime model, accumulated exposure of the component to the one or more factors; and
determining, using the accumulated exposure of the component, a remaining lifetime of the component.

20. The method of claim 19, wherein the one or more sensors include a thermostat to measure temperature, a vibration sensor to measure vehicle vibration, an odometer to measure vehicle mileage, and/or a humidity sensor to measure humidity.
